(19) United States
(12) Patent Application Publication
(10) Pub. No.: US 2014/0073190 A1
(43) Pub. Date: Mar. 13, 2014

(54) SOCKET CONNECTOR WITH A SUB-SHELL FLEXIBLY CONNECT WITH A PRINTED CIRCUIT BOARD

(71) Applicant: HON HAI PRECISION INDUSTRY CO., LTD., New Taipei (TW)

(72) Inventors: JUN ZHAO, Shenzhen (CN); JING-JIE GUO, Shenzhen (CN)

(73) Assignee: HON HAI PRECISION INDUSTRY CO., LTD., New Taipei (TW)

(21) Appl. No.: 14/023,813

(22) Filed: Sep. 11, 2013

(30) Foreign Application Priority Data
Sep. 11, 2012 (CN) 201220459789.3

(51) Int. Cl. H01R 13/516; H01R 43/18

(52) U.S. Cl. CPC H01R 13/516; H01R 43/18
USPC 439/626; 29/883

(57) ABSTRACT

A socket connector (100) includes an insulating housing (1), a number of terminals (2) retained in the insulating housing (1), a metallic shell (4) covered the insulating housing (1), an insulative cover (5) covered the metallic shell (4) and the insulating housing (1) by over molding, and a sub-shell (6) covered the insulative cover (5). The sub-shell (6) includes a base part (61) and a plurality of elastic arms (62) extending downwardly from the base part (61), the elastic arms (62) and the terminals (2) flexibly connect with a printed circuit board (PCB) therefore, the socket connector (100) has good connection between terminals (2) and PCB and is convenient to be disassembled from the PCB when repair.

### BACKGROUND OF THE INVENTION

1. Field of the Invention

The present invention relates generally to a socket connector, and more particularly to a socket connector which has good connection between contacts and a printed circuit board (PCB) and is convenient to be disassembled from the PCB when repair.

2. Description of Related Arts

Universal Serial Bus (USB) interfaces are widely used in various electronic devices. In recent years, a micro USB interface is introduced to meet miniaturization requirement of electronic devices. Taiwan Utility Model No. M385114 discloses a receptacle electrical connector comprising an insulative cover, an insulating housing assembled into the insulative cover, and a plurality of terminals retained in the insulating housing. The terminal has a resilient arm. The resilient arm defines a connecting portion. The elastic arms flexibly connect with a printed circuit board without soldering. Therefore, the receptacle electrical connector is very unsteady with respect to the the printed circuit board instable, and the electromagnetic shielding performance is not good.

A socket connector that can be securely fixed to a printed circuit board and easily disassembled from the PCB when repairing.

### SUMMARY OF THE INVENTION

Accordingly, an object of the present invention is to provide an electrical connector securely fixed to a printed circuit board (PCB) and easily disassembled from the PCB when repairing.

To achieve the above object, A socket connector comprises an insulating housing, a plurality of terminals retained in the insulating housing, a metallic shell covered the insulating housing, an insulative cover covered the metallic shell and the insulating housing by over molding, and a sub-shell covered the insulative cover. The sub-shell includes a base part and a plurality of elastic arms extending downwardly from the base part, the elastic arms flexibly connect with a printed circuit board without soldering for grounding and preventing EMI (electromagnetic interference).

Other objects, advantages and novel features of the invention will become more apparent from the following detailed description when taken in conjunction with the accompanying drawings.

### BRIEF DESCRIPTION OF THE DRAWINGS

FIG. 1 is a perspective, assembled view of a socket connector of the present invention;

FIG. 2 is another perspective, assembled view of the socket connector but taken a different view with respect to FIG. 1;

FIG. 3 is a perspective, exploded view of the socket connector taken a same view with respect to FIG. 1; and

FIG. 4 is a perspective, exploded view of the socket connector taken a same view with respect to FIG. 2.

### DETAILED DESCRIPTION OF THE PREFERRED EMBODIMENT

Reference will now be made in detail to the preferred embodiment of the present invention.

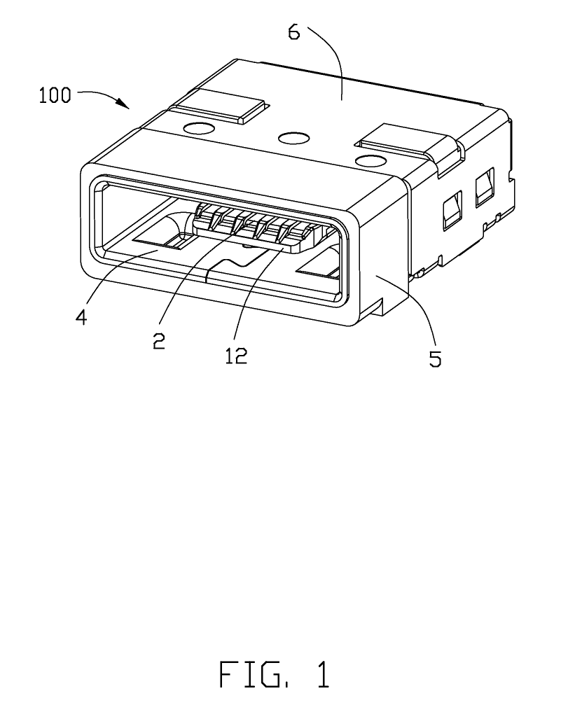

Referring to FIGS. 1 to 4, a socket connector 100 of the present invention comprises an insulating housing 1, a plurality of terminals 2 and a metal plate 3 retained in the insulating housing 1, a metallic shell 4 covering the insulating housing 1, an insulative cover 5 covering the metallic shell 4, and a sub-shell 6 covering the insulative cover 5. The sub-shell 6 covering a upper surface, a pair of side surface and a rear surface of the insulative cover 5. The nouns of locality “bottom, front, rear” are not meant to be limiting but are descriptive of depiction according to the claims.

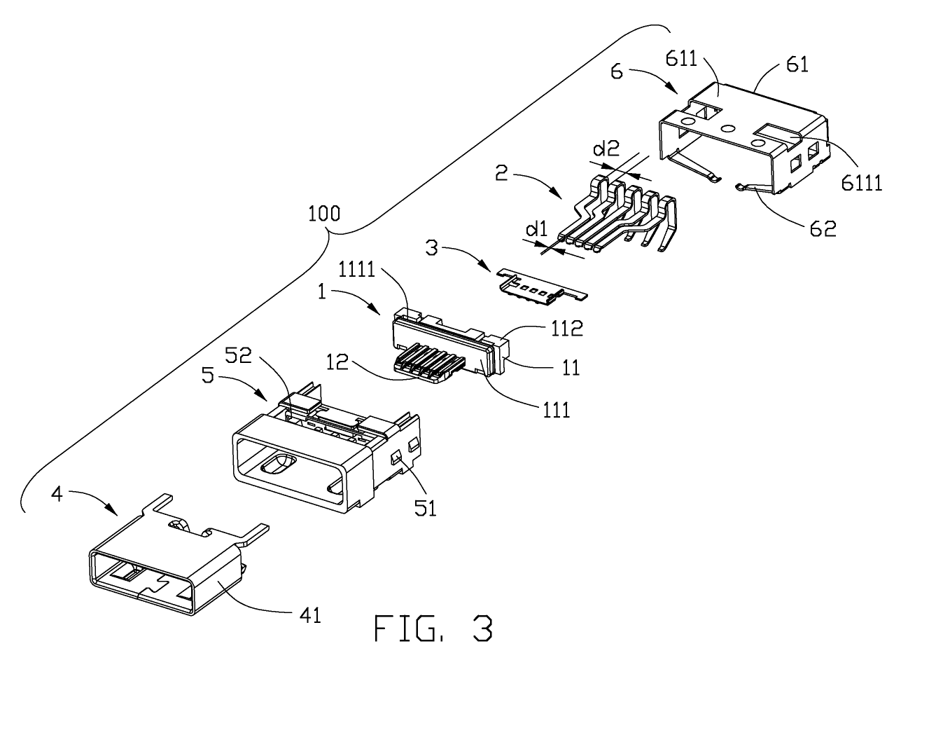

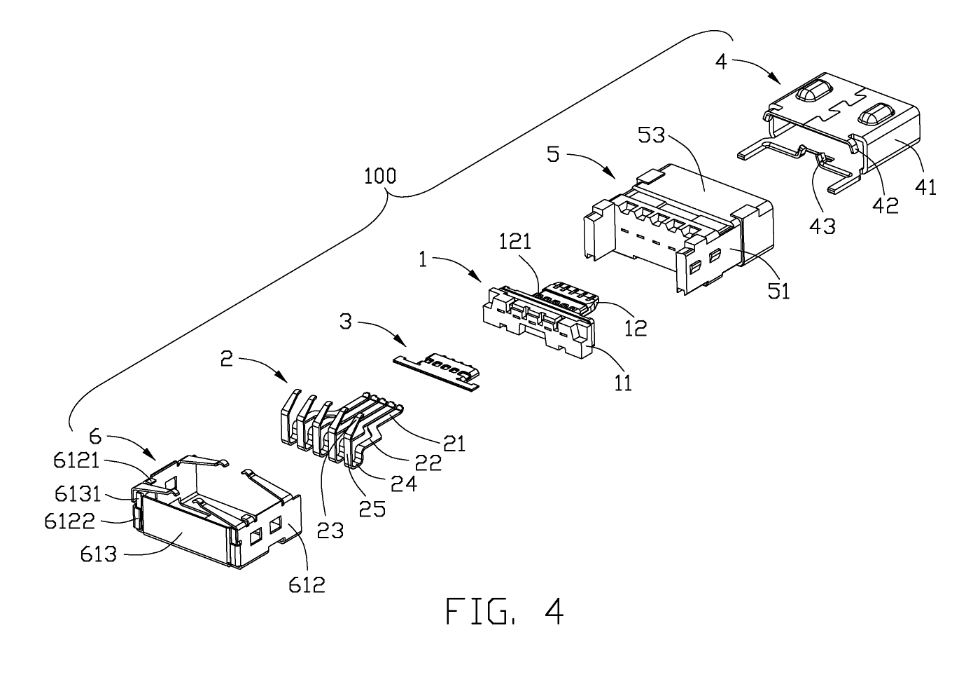

Referring to FIGS. 3 and 4, the insulating housing 1 comprises a base portion 11 and a tongue portion 12. The tongue portion 12 extends from the base portion 11 and forwardly into a receiving room (not shown) of the metallic shell 4. The base portion 11 includes a front base portion 111, and a rear base portion 112 abuts against the front base portion 111. The front base portion 111 comprises a rib 1111. The rib 1111 extendes and arounds from a outside surface of the front base portion 111. The rib 1111 prevents plastic overflow when the insulative cover 5 covering the metallic shell 4 by over molding. The front end of the tongue portion 12 has a width narrower than that of the other part of the tongue portion 12 and therefore, a mating connector (not shown) is inserted into the socket electrical connector 100 easily. The tongue portion 12 defines a plurality of location holes 121 for inserting location molds (now show). The terminals 2 and said metal plate 3 are fixed with each other by the location molds inserting into the location holes 121 for inser-molding.

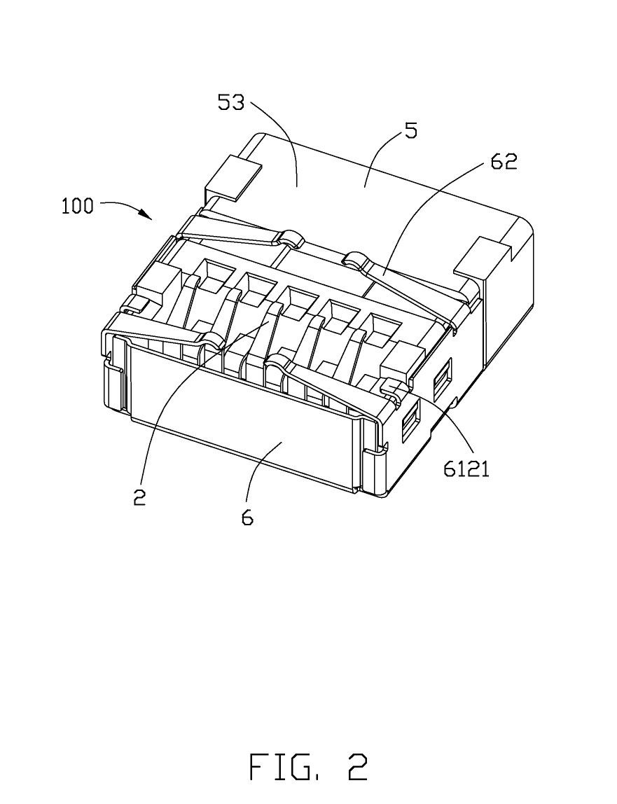

Referring to FIGS. 2 to 4, the terminals 2 are insert-molded in the insulating housing 1. Each terminal 2 comprises a contacting portion 21 extending beyond the tongue portion 12 and extending into the receiving room (not shown) for connecting with the mating connector, a retaining portion 22 extending from a rear end of the contacting portion 21 and being fixed in the base portion 11 of the insulating housing 1 by insert-molding, a elastic leg 23 extending out of a back wall of the insulating housing 1, and a n-shaped connecting portion 24 connecting the elastic leg 23 and the retaining portion 22. The front end of the contacting portion 21 defines a lead portion 221. The lead portion 221 can be used to guide the mating connector inserted into the socket electrical connector 100 easily. A space between each two adjacent contact portions 21 is narrower than that between each two adjacent connecting portions 24 and therefore, the elastic legs 23 securely flexibly connect with the printed circuit board. The elastic leg 23 extends downwardly and forwardly from a free end of the connecting portion 24. A vertical portion 25 is connected between the elastic leg 23 and the connecting portion 24.

Referring to FIGS. 3 and 4, the metal plate 3 is insert-molded in the insulating housing 1 for reinforcing rigidity of the tongue portion 12. The metal plate 3 coveres a lower surface of the tongue portion 12, and at least coveres one of the side surface of the tongue portion 12.

Referring to FIGS. 2 to 4, the metallic shell 4 comprises a tube-shaped base part 41 covering the insulative housing 1. The tubular base part 41 comprises a plurality of fixing pieces 42,43 at a free end thereof, Each fixing piece 42,43 corresponding protrudes into a receiving room (no shown) of the insulating housing 1 for securing the metallic shell 41 and the insulative housing 1. The receiving room located at the rear end of the insulating housing 1.

Referring to FIGS. 1 to 4, the insulative cover 5 is covered the metallic shell 4 and the insulative housing 1 by over molding for waterproof The insulative cover 5 has a plurality of side fixing portions 51 and a through hole 52. The fixing portions 51 located at a top wall and side walls of the insulative cover 5. The fixing portions 51 are fixed with the sub-shell 6. The sub-shell 6 is slodered with the metallic shell 4 via the through hole 52.

Referring to FIGS. 2 to 4, the sub-shell 6 is made by metallic material, the sub-shell 6 includes a base part 61 and a plurality of incline elastic arms 62. The base part 61 includes a top wall 611, a pair of side walls 612 extending downwardly from two opposite sides of the top wall 611, and a rear wall 613 extending downwardly from a rear end of the top wall 611. Each the side wall 612 and the top wall 611 defines a plurality of fixing holes 6111. Each fixing hole 6111 is fixed with the fixing portions 51 of the insulative cover 5 for securing the sub-shell 6 and the insulative cover 5. Each the side wall 612 has a retaining piece 6121 extending from thereof. The retaining piece 6121 is essentially parallel to the top wall 611. The retaining pieces 6121 are retained with the insulative cover 5. The incline elastic arms 62 extends downwardly from a free end of each side wall 612. The elastic arm 62 and the top wall 611 are faced to each other. According to the illustrated embodiment of the present invention, each side wall 612 has two incline elastic arms 62. The retaining piece 6121 is located between the two same side incline elastic arms 62. Each incline elastic arms 62 on one side wall 612 extends toward to the other side wall 612. The incline elastic arms 62 securely flexibly connect with the printed circuit board for grounding and preventing EMI (electromagnetic interference). The vertical portions 25 of the terminals 2 are located between the back wall of the insulative cover 5 and the rear wall of the sub-shell 6. The real wall 613 has an edge portion 6131 at each side thereof, and each side wall 612 has an extension portion 6122 engaged with the edge portion 6131.

Referring to FIGS. 1 to 4, now will be made to introduce the assembly process of our illustrated embodiment of the present invention. First, The terminals 2 and the metal plate 3 are fixed with each other by the location molds, then, the terminals 2 and the metal plate 3 are insert-molded with the insulating housing 1. Second, the metallic shell 4 is covered on the insulating housing 1, Third, the insulative cover 5 is covered on the metallic shell 4 and the insulative housing 1 by over molding for waterproof Last, the sub-shell 6 is covered on the insulative cover 5 and soldering with the metallic shell 4. According to the illustrated embodiment of the present invention, the socket electrical connector 100 fixes on the printed circuit board by the elastic arms 62 and the elastic legs 23 flexibly connect with the printed circuit board without soldering and therefore, the socket electrical connector 100 is convenient to be disassembled. The metallic shell 4 is connected with the sub-shell 6 for grounding and preventing EMI.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A socket connector comprising:
an insulating housing comprising a base portion and a tongue portion extending from the base portion;
a plurality of terminals retaining in the insulating housing;
a metallic shell covering the insulating housing;
an insulative cover covering the metallic shell and the insulating housing, the insulative cover has a mounting face facing to a printed circuit board; and
a sub-shell covering the insulative cover, the sub-shell including a base part and a plurality of elastic arms extending from the base part to be located below the mounting face of the insulative cover.

2. The socket connector as claimed in claim 1, wherein the base part includes a top wall and a pair of side walls extending downwardly from two opposite sides of the top wall, the elastic arms extends downwardly and obliquely from a free end of each side wall.

3. The socket connector as claimed in claim 2, wherein each side wall has a retaining piece extending from the side wall, the retaining piece is essentially parallel to the top wall, and the retaining piece is retained with the insulative cover.

4. The socket connector as claimed in claim 2, wherein the base part includes a real wall extending downwardly from a rear end of the top wall, the real wall has an edge portion at each side thereof, and each side wall has an extension portion engaged with the edge portion.

5. The socket connector as claimed in claim 4, wherein each terminal comprises a contacting portion extending beyond the tongue portion, a retaining portion extending from a rear end of the contacting portion, an elastic leg extending out of a back wall of the insulative cover, and a connecting portion connecting the elastic leg and the retaining portion, the elastic leg flexibly connect with the printed circuit board.

6. The socket connector as claimed in claim 5, wherein the connecting portion includes a vertical portion connected to the elastic leg, and the vertical portion is located between the back wall of the insulative cover and the rear wall of the sub-shell.

7. The socket connector as claimed in claim 5, wherein a space between each two adjacent contact portions is narrower than that between each two adjacent connecting portions.

8. The socket connector as claimed in claim 5, wherein the elastic legs extend obliquely forward to the contacting portions opposite to a mating direction along which a plug connector is inserted in the socket connector.

9. The socket connector as claimed in claim 8, wherein the elastic arms extend along a transverse direction perpendicular to the mating direction.

10. The socket connector as claimed in claim 1, wherein the insulative cover includes a fixing portion, the sub-shell has a fixing hole and the fixing hole correspondingly fixed with the fixing portion.

11. The socket connector as claimed in claim 1, wherein the base portion includes a front base portion and a rear base portion abuting against the front base portion, and the metallic shell peripherally covering the front base portion.

12. The socket connector as claimed in claim 1, wherein the insulative cover covers the metallic shell and the insulative housing by over molding, the insulative cover has a through hole an a top wall thereof, the sub-shell is slodered with the metallic shell via the through hole.

13. A socket connector comprising:
an insulative housing defining a body portion with a mating tongue extending forwardly from the body portion;
a plurality of contacts disposed in the housing with front contacting sections exposed upon the mating tongue and rear resilient tail sections;
an inner metallic shell enclosing the housing to form an initial sub-assembly;
an insulative cover enclosing the initial sub-assembly to form an intermediate sub-assembly; and
an outer metallic shell enclosing the intermediate sub-assembly to form a final assembly; wherein
at least one of the insulative cover and the outer metallic shell defines a confined area, in a top view, in which the resilient tail sections are located.

14. The socket connector as claimed in claim 13, wherein said tail sections are deflected by a printed circuit board on which the connector is mounted.

15. The socket connector as claimed in claim 13, wherein the outer metallic shell defines a plurality of resilient legs adapted to be upwardly deflected by a printed circuit board on which the connector is mounted, and said insulative cover defines space to receive the deflected resilient legs.

16. The socket connector as claimed in claim 13, wherein the inner metallic shell is configured to be assembled to the housing in a front-to-back direction while the second metallic shell is configured to be assembled upon the insulative cover in a vertical direction perpendicular to said front-to-back direction.

17. The socket connector as claimed in claim 13, further including a metallic reinforcement plate including a shielding plate covering one face of the mating tongue, and at least one leg mechanically and electrically connected to at least one of the inner shell and outer shell.

18. A method of assembling an electrical connector comprising:
providing an insulative housing with a body portion and a mating tongue forwardly extending from the body portion;
integrally forming said housing with a plurality of contacts via an insert molding procedure;
assembling an inner metallic shell upon the housing to form an initial sub-assembly;
applying an insulative cover upon the initial sub-assembly via an overmolding process to for an intermediate sub-assembly; and
assembling an outer metallic shell upon the intermediate sub-assembly to from a final assembly.

19. The method as claimed in claim 18, wherein the inner metallic shell is assembled in a front-to-back direction while the outer metallic shell is assembled in a vertical direction perpendicular to said front-to-back direction.

20. The method as claimed in claim 18, wherein in the insert molding procedure, a metallic reinforcement plate is associated with the housing, and said reinforcement plate defines a leg to mechanically and electrically contact at least one of the outer shell and the inner shell.
